(19) United States
(12) Patent Application Publication
(10) Pub. No.: US 2008/0269553 A1
(43) Pub. Date: Oct. 30, 2008

(54) Powered massager for internal use on the human body

(75) Inventor: Simon Siu Man Nan, Ontario (CA)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: Nanma Manufacturing Co., Ltd., Ontario (CA)

(21) Appl. No.: 11/796,191

(22) Filed: Apr. 27, 2007

(51) Int. Cl. A61H 21/00

(52) U.S. Cl. 600/38

(57) ABSTRACT

A powered massager device for internal use on the human body for providing sexual stimulation or other massage or therapeutic purposes by internal or external uses on the human body by vibration actuation. It includes a vibration actuator unit including a vibration generator, and a control interface unit separated from but electrically connected to the vibration actuator for controlling the vibration actuator. The vibration actuator unit is sized for being receivable in its entirety in a body cavity of the user. the vibration actuator unit having externally shape in the form of first and second integrally joined sections, each section having a rounded outer end, the sections providing a smooth transition from the first section to the second section, the sections forming an angle between them in the semblance of a bent fingertip.

### BACKGROUND AND SUMMARY

The present invention relates generally to sexual assistance or marital aid devices and, more particularly to an electrically powered and programmed controlling massager useful for sexual assistance or marital aid or therapeutic use, the massager having all functional units of massage actuator, power source and control means compactly integrated such that the massager may be completely inserted into the human organs for delivering the massage operation functions.

Known art sexual aid or vibration stimulating devices with massage actuators such as vibrators designed for internal or external use on the human body generally have two portions, namely an actuation portion and a hand-held portion, and having the control interface devised on the hand-held portion. In the application of internal use, such known type of massage actuator will be inserted to the human organ and, the hand-held portion will be left outside the human body for holding and controlling purposes.

With the usual known arrangement of disposing the hand-held portion to the outside of the human body, the user is required to at least use one hand to hold the vibrator and this is easy to cause user's fatigue in the application. Also, in many situations of the sexual pleasure application, it desirable for sexual partners being able to use two arms/hands during the application. Further, with a portion of the vibrator disposed outside the human body in the sexual stimulation or therapeutic application, it will very much limit body movement so as to avoid accidentally injuring the user's organ caused by a too deep penetration of the vibrator into the organ.

Some other known vibrators or massagers for the internal use may be able to have a portion that can be completely inserted into the human organ, but they usually have to connect to an external unit such as power source and control device. However, with the connections between the internal vibrator and the external units, this will very much limit body movement during the application; inevitably downgrading the satisfaction level for the vibrator being used for sexual stimulation or therapeutic applications.

It is be desirable to provide the user with the massage device which is completely inserted into the human organ to overcome the aforementioned shortcomings of the existing designs. It is also desirable to have the massage device with variable controlled operations compactly integrated into the device without external connections. However, the idealities expected from the massager stated above apparently have been long overlooked in existing designs. The aforementioned shortcomings of existing designs make the existing massagers can not meet all the objectives and advantages described below. The present invention was therefore developed to provide for a massage device for internal use on the human body for providing advantages over known types of devices mentioned above.

Among the advantages, benefits, features, goals and objectives relative to the present invention are:

the provision of a powered massage device for providing sexual stimulation or other therapeutic purposes which can be used both for internal and external uses on the human body; and which of shaped as a bent finger (dactyl);

the provision of a powered massage device which can conveniently be operated for use of the device while located inside a human organ;

the provision of a powered massage device with all function units compactly integrated such that there is no need to incorporate any connection with external power or control devices which may hinder the user's application especially in the sexual pleasure exercise between the sexual partners;

the provision of a powered massage device which eliminates the need of manually holding the massage device during its application; and

the provision of such a powered massage device for providing sexual stimulation to the user for internal use that will not have a risk of injury to the user by penetrating the massage device too deeply into the human organ, e.g., a body cavity.

The terms “objective” and “goal” and “aim” if and when used herein are not intended to be limiting or rigorous or definitive but rather are used to demonstrate laudable and advantageous features, as well as benefits and desirable achievements relative to the invention. They will be in part apparent or made clearer in the following description and drawings.

### DRAWINGS

FIG. 1 shows a perspective-type view of a massage device of the present invention, and

FIG. 2 shows an exploded view of the components making up the device of FIG. 1.

FIG. 2A shows a portion of an exploded view of the components making up the device of FIG. 1, as taken in the general direction indicated by arrow A.

FIG. 3 shows a perspective-type view of the device of FIG. 1 with the end cover and batteries detached from the vibration actuator.

FIG. 3B shows a portion of the perspective-type view of the device of FIG. 2 as taken in the general direction indicated by arrow B.

Corresponding reference characters signify corresponding parts throughout the drawings.

### DESCRIPTION

An electrically powered and programmed controlling massage device of the invention generally comprises a vibration actuator encasing a power source and a vibration generator. It also comprises a miniature control interface unit. The actuator is connected to the control interface unit by flexible power and signal cables. The electronic hardware and software, firmware or hardware for controlling the actuator operation are encased in the actuator.

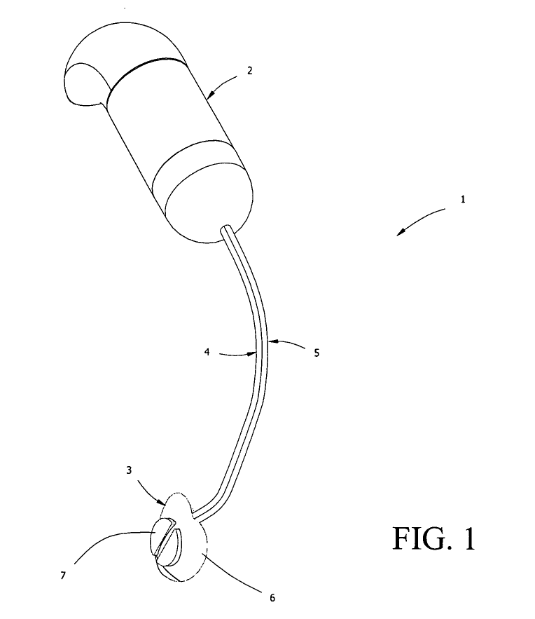

Referring to FIG. 1, in an embodiment of the present invention, powered massage device 1 comprises a vibration actuator 2 encasing the vibration generator, batteries and control circuit, a control interface unit 3 having a top cover 6 and control buttons 7, and power cables, i.e., leads, 4 and 5 interconnecting vibration actuator 2 and control interface unit 3.

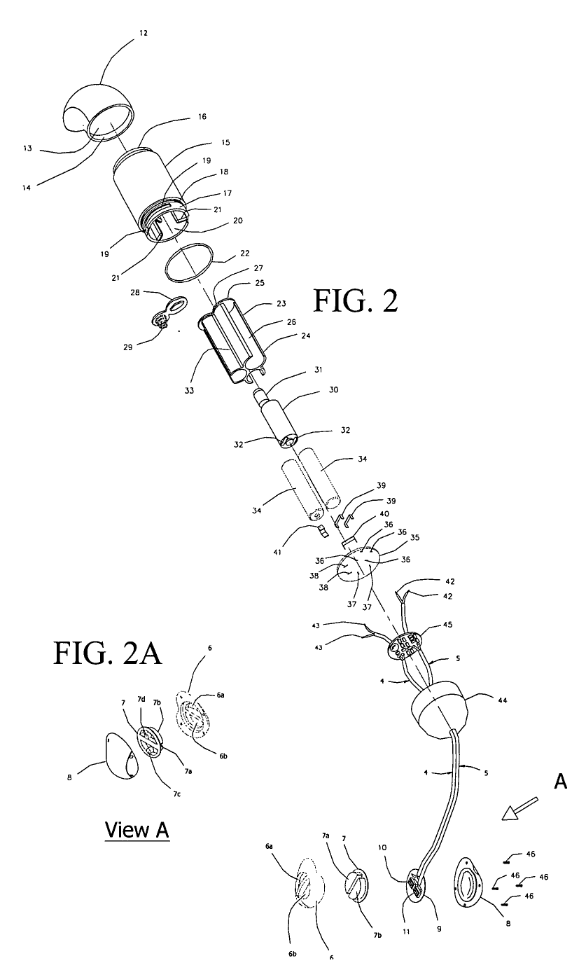

Referring to FIG. 2, control interface unit 3 comprises a user control housing having an upper cover 6 having windows 6a and 6b on the top surface, a push-pad 7 made of resilient material having pushing portions 7a and 7b (which is to say portions to be pressed by a user), a lower casing 8, a printed circuit board (PCB) 9 holding push (pushbutton operated) switches 10 and 11, and a set of screws 46 for fastening lower casing 8 onto upper cover 6. On the interior sides of pushing portions 7a and 7b there are respective pressing posts 7c and 7d (View A; FIG. 2A). When control interface unit 3 is assembled, pushing portions 7a and 7b of the push-pad will respectively be located in windows 6a and 6b of upper cover 6; and pressing posts 7c and 7d will respectively be disposed on push switches 10 and 11. Leads of one end of power cables 4 and 5 are soldered on PCB 9.

Vibration actuator 2 has its outermost housing formed by a head cover 12, a cylindrical casing 15 with one opening 20 at the proximal end, and an end cover 44. Head cover 12 can be made in different configurations, and also can be made of various materials with different rigidities. According to an embodiment, the head cover forms an off-axis extension which, as considered a part of the overall housing or enclosure, brings about a shape of the actuator simulative of a bent finger (dactyl).

More specifically, head cover 12 has an opening 13 with a circular step hole 14 for fitting it to a shoulder circular portion 16 on the distal end of casing 15. In the manufacturing process, head cover 12 is permanently bonded onto cylindrical casing 15 at circular portion 16 such that a water-tight sealing is established at the seam. On the proximal end of cylindrical casing 15 there is a shoulder circular portion 17 defining an opening 20. On the outer circumference of circular portion 17 there are two L-shape recesses 19 disposed at an opposite direction on the circular portion for providing a means of locking end cover 44. There is a circular recess 18 on the circumference and at the shoulder of the circular portion 17 for accommodating a sealing element 22 made of resilient material. On the interior surface of cylindrical casing 15 there are three longitudinal ribs 21 circumferentially disposed.

Cartridge 23 has a number of pairs of curved side-walls 24 and a base plate 25 at the distal end. Each pair of the side-walls internally defines a chamber 26 for respectively accommodating a battery 34 and an electric motor 30. Outside the chambers, the two adjacent side-walls externally define a space 33 for providing a clearance to rib 21 when the cartridge is inserted into casing 15. There is a slot 27 in between base plate 25 and distal ends of the side-walls of the battery chambers. Metallic contact plate 28 has two circular discs; one of the discs is mounted with a metallic spring 29. Contact plate 28 is inserted through slot 27 into the distal end of battery chambers 26, such that each disc is located in the end of a battery chamber. Electric motor 30 has a cylindrical outside shape with the external diameter fitting into the chamber on the cartridge. A mass 31 is eccentrically mounted on the motor shaft, such that the rotating of the motor shaft will generate a vibration which is in turn conveyed by the elements of construction out through casing 15. Electric motor 30 has two electric poles 32 for providing electrical flow from the batteries.

Mounting plate 35 has through slots 36, 37 and 38 which are for respectively mounting metallic contact plates 39, 40 and 41. Contact plates 39 are for contacting motor poles 32. Contact 40 and 41 are for contacting the battery poles. A control circuit PCB 45 has electronic hardware and control software/firmware with the operation program built in. Power cables 4 and 5 come from control interface unit 3 and across end cover 44 are soldered on control PCB 45. Controlled power will be provided to the motor by cables 42. Power from the batteries will be collected through cables 43. In the manufacturing process, mounting plate 35 will be fixed into end casing 44 to cover PCB 45 inside the casing.

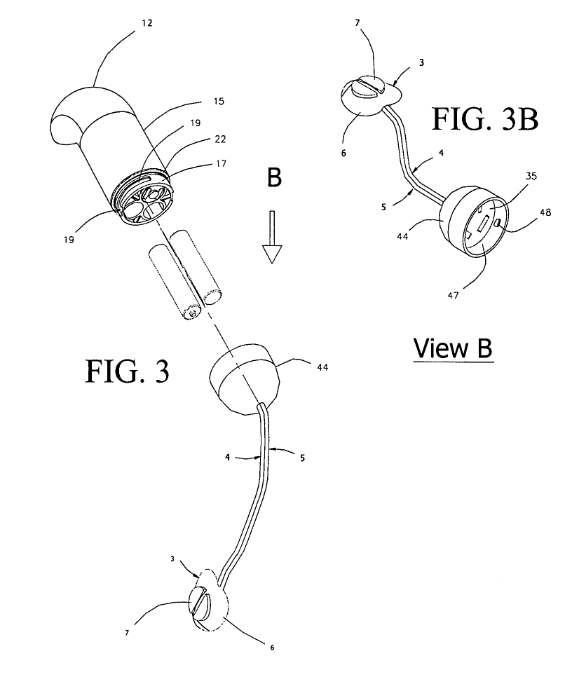

Now referring to FIG. 3, on the internal surface and near the edge of opening 47 of end cover 44 there are two blocks 48 protruded inwardly which are disposed at mutually opposite directions. When end cover 44 is brought in place to close casing 15, blocks 48 are engaged with recesses 19 and then end cover 44 is twisted relative to casing 15 for tightening. This will tighten end cover 44 onto the casing 15 which squeeze sealing element 22 and establish water-tight sealing between the cover and the casing.

According to a preferred embodiment, vibration actuator 2, as considered as an integrally assembled vibrator unit together with its head cover 12, i.e., distal end portion 12, cylindrical casing 15 and end cover, i.e., proximal end portion 44, is sized for being receivable in its entirety in a body cavity of the user, as for example in the human vagina.

As is seen, all functional units of the massage actuator 2, including the vibration generator, the battery power source for the vibration generator and control circuitry for the vibration generator are all compactly integrated into the housing of the massage actuator, such that the massage actuator may be completely inserted into a body cavity.

From the foregoing, one can appreciate a possible use of an embodiment of the invention. This, user-operated controls are provided by user control housing (e.g., 6), and control cabling 4,5 extends between the control interface unit 3 and the massage unit 2, such that if the massage actuator is completely inserted into a body cavity, the user control housing is not within said body cavity, whereby the massage actuator is controllable from outside of said body cavity.

Unit 2 can also be visualized when considered from an overall point of view as configured in the form of first and second integrally joined sections or portions, wherein the first section is formed by casing 15 and its end portion 44, and the second section is a distal section formed by head cover 12, which turns relatively abruptly laterally outwardly from the casing, that is pointing laterally outwardly with bent finger-forming aspect. More specifically, each of these two sections is of generally curvilinear cross section (the first section preferably having a circular outer surface) but elongated along an axis of elongation, and each having a rounded outer end. Thus, head cover 12 forms a distal rounded conical outer end, while end portion 44 forms a proximal rounded outer end. These first and second sections, or portions, provide a smooth transition from the first section to the second section, the axes of elongation relative to the transition being other than colinear and forming an included angle between them of about 90 degrees or greater and less than about 180 degrees, being preferably about 90 to about 125 degrees. The first section is substantially longer than the second section, such that the second section forms a projection extending angularly and smoothly from the first section, rather much in the semblance of a bent fingertip.

The configuration and separate control interface unit also provide the advantage that this new powered massage device can provide sexual stimulation to the user for internal use that will not have a risk of injury to the user by penetrating the massage device too deeply into the human organ, e.g., a body cavity.

In view of the foregoing description of the present invention and various embodiments and methods it will be seen that the several objects of the invention are achieved and other advantages are attained.

As various modifications could be made in the constructions and methods herein described and illustrated without departing from the scope of the invention, it is intended that all matter contained in the foregoing description or shown in the accompanying drawings shall be interpreted as illustrative rather than limiting.

1. A powered massage device for providing sexual stimulation or other massage purposes by internal or external uses on the human body by vibration actuation, the device comprising:
a vibration actuator including a vibration generator;
a control interface unit separated from but electrically connected to the vibration actuator for controlling the vibration actuator;
the vibration actuator being sized for being receivable in its entirety in a body cavity of the user,
the vibration actuator having a housing of external shape in the form of first and second integrally joined sections, each of generally curvilinear cross section elongated along an axis of elongation, and each having a rounded outer end, the sections providing a smooth transition from the first section to the second section, the sections forming an angle between them.

2. The powered massage device of claim 1 wherein all functional units of the vibration actuator, including the vibration generator, a power source for the vibration generator and control circuitry for the vibration generator are all compactly integrated into the housing of the vibration actuator, such that the vibration actuator may be completely inserted into a body cavity.

3. The powered massage device of claim 2 wherein the control interface unit includes a control housing providing user-operated controls for the vibration actuator, the user-operated controls providing functional control for said control circuitry, and the user-operated controls being capable of operation remotely from the housing of the vibration actuator.

4. The powered massage device of claim 3 wherein the user-operated controls are provided by a user control housing, and control cabling extends between the control interface unit and the vibration actuator, such that if the vibration actuator is completely inserted into a body cavity, the user control housing is not within said body cavity, whereby the massage actuator is controllable from outside of said body cavity.

5. The powered massage device of claim 3 wherein the user-operated controls comprises a pair of side-by-side push surfaces for user actuation, said push surfaces extending from a surface of the user control housing.

6. A powered massage device for providing sexual stimulation or other massage purposes by internal or external uses on the human body by vibration actuation, the device comprising:
a vibration actuator including a vibration generator;
a control interface unit separated from but electrically connected to the vibration actuator for controlling the vibration actuator;
the vibration actuator being sized for being receivable in its entirety in a body cavity of the user,
the vibration actuator unit having externally shape in the form of first and second integrally joined sections, each of generally curvilinear cross section elongated along an axis of elongation, and each having a rounded outer end, the sections providing a smooth transition from the first section to the second section, the axes of elongation relative to the transition being other than colinear and forming an included angle between them of about 90 degrees or greater and less than about 180 degrees, the first section being substantially longer than the second section, such that the second section forms a projection extending angularly and smoothly from the first section, in the semblance of a bent fingertip.

7. The powered massage device according to claim 6 wherein the second section is of conical configuration having progressively smaller cross-section from the transition to the outer end thereof.

8. The powered massage device according to claim 6 wherein the outer end of the first section is of substantially hemispherical shape, and the outer end of the second section is of much smaller substantially hemispherical shape.

9. The powered massage device according to claim 6 wherein the first section of substantially of cylindrical shape terminated in its outer end which of substantially hemispherical shape, and wherein the second section of substantially of conical shape having progressively smaller cross-section from the transition to the outer end thereof, the transition being defined by smooth transition from cylindrical shape of the first section to conical shape of the second section so as to define a cylindriconical characteristic of the transition.

10. The powered massage device according to claim 6 wherein the axes of elongation relative to the transition form an included angle between them of about 90 degrees 90 to about 125 degrees.

11. A powered massage device for providing sexual stimulation or other massage purposes by internal or external uses on the human body by vibration actuation, the device being capable of while located inside a human organ, the device comprising:
a vibration actuator,
the vibration actuator including a vibration generator, batteries for powering the vibration generator, and control circuitry,
control interface unit for controlling the vibration actuator,
the control interface unit including a cover and control buttons accessible at a surface thereof, and including power leads interconnecting the vibration actuator and the control interface unit,
the vibration actuator having a water-tight enclosure,
the enclosure being sized for being receivable in its entirety in a cavity of an organ of the user,
the enclosure having externally shape in the form of first and second integrally joined sections, each of generally curvilinear cross section elongated along an axis of elongation, and each having a rounded outer end, the sections providing a smooth transition from the first section to the second section, the axes of elongation relative to the transition being other than colinear and forming an included angle between them of about 90 degrees or greater and less than about 180 degrees, the first section being substantially longer than the second section, such that the second section forms a projection extending angularly and smoothly from the first section, in the semblance of a bent fingertip,
there being contained in water-tight relation within the enclosure the vibration generator and the batteries for powering the vibration generator under control provided by the power leads for causing selective vibration actuation of the casing,
whereby there is avoided any need to incorporate any connection with external power or control devices which may hinder the user's application of the massage device during operation.

12. A powered massage device according to claim 11 wherein the second section is of conical configuration
having progressively smaller cross-section from the transition to the outer end thereof.

13. A powered massage device according to claim 11 wherein the outer end of the first section is of substantially hemispherical shape, and the outer end of the second section is of much smaller substantially hemispherical shape, the first section being of substantially of cylindrical shape terminated in its outer end which of substantially hemispherical shape, and wherein the second section of substantially of conical shape having progressively smaller cross-section from the transition to the outer end thereof, the transition being defined by smooth transition from cylindrical shape of the first section to conical shape of the second section so as to define a cylindriconical characteristic of the transition.

14. A powered massage device according to claim 11 wherein the second section is of substantially conical pointed shape, a distal section formed by head cover, which turns relatively abruptly laterally outwardly from the first section, pointing laterally outwardly with bent finger-forming aspect, including a distal tip of rounded configuration.
